(19) United States
(12) Patent Application Publication
(10) Pub. No.: US 2026/0226881 A1
(43) Pub. Date: Aug. 6, 2026

(54) TURBINE WITH MOVING BLADES USING SHALLOW FLOW

(71) Applicant: Norwegian Water Power Solution AS, Mosjøen (NO)

(72) Inventors: Frank Arne NORDÅS, Mosjøen (NO); Jonas Andre NORDÅS JOHNSEN, Mosjøen (NO)

(21) Appl. No.: 19/154,346

(22) PCT Filed: Jan. 29, 2024
(86) PCT No.: PCT/NO2024/050022

§ 371 Date: Aug. 6, 2025

(30) Foreign Application Priority Data
Feb. 8, 2023 (NO) 20230125

(51) Int. Cl. F03B 17/06

(52) U.S. Cl. CPC F03B 17/068

(57) ABSTRACT

A turbine including multiple blades on at least one continuously shaped belt, adapted to be run in a loop, where each blade is rotatably secured with its first end to the inside of the belt and is arranged to fold out from the belt, toward the center of the loop, to be carried with the flow of a fluid, and is arranged to fold in toward the belt when the blade is led against the flow.

### TECHNICAL FIELD

The invention relates to a turbine with moving blades for maximum utilization of flowing fluid, especially a submersible current-generating turbine for efficient utilization of shallow currents in rivers and tides. It may also be used in ocean surface currents and in the depth, as well as in the wind and generally in any flowing fluid. It utilizes energy in rivers with low drop height and avoids the need for damming.

### BACKGROUND

The current situation in hydropower is dominated by turbines with a typical drop height of at least a couple of meters, preferably many tens of meters. There are few alternatives available for turbines with a drop height, one of the known solutions being based on a longitudinal pipe located on the bottom of a river with a longitudinal rotating turbine inside the pipe, which is used in micro powerplants.

At the same time, there are many rivers with varying water flow and considerable unrealized power potential, in particular, because damming is made impossible, for example, by the terrain or environment, which does not allow for the construction of dams. That is why there is a need for a solution, which utilizes the energy in rivers with low drop heights without a dam.

### SUMMARY

The purpose of the invention, based on the described state of the art, is to provide a solution capable of utilizing the energy in rivers with a low drop height.

The above goal is achieved, according to the invention, using a turbine with the characteristics according to claim 1. Beneficial and preferred embodiments of the invention are stated in the subclaims.

The turbine comprises at least three blades on at least one annular belt running as a loop/ring, wherein each blade is rotatably secured with its first end to the inside of the belt and is arranged to fold out from the belt, toward the center of the loop, to be carried with the flow of the fluid, and is arranged to fold in toward the belt when the blade is led against the flow. The turbine may be provided with a plow that mostly directs the fluid flow toward one edge of the turbine.

This is achieved by a solution comprising at least one annularly connected (“infinite”) belt. The belt may be guided by multiple diversion devices, such as walls or restrictive guides, mostly parallel to the surrounding flow. Attached to the belt are blades tilting from a position mostly parallel to the running direction of the belt to a position mostly perpendicular to the belt when the blades are moving with the flow, and the blades are put down again into the position mostly parallel to the running direction of the belt when the blades are moving against the flow. A thrust from the flow is transmitted by the blades to the belt, which in turn converts the thrust into a rotational torque by using at least one of the diversion devices, upon which the rotational torque can drive an apparatus, which can use the rotational torque.

### BRIEF DESCRIPTION OF THE DRAWINGS

The invention will now be described in more detail with reference to the drawing figures showing several embodiment examples, where

FIG. 1 shows the pictorial schematic with a turbine in bird's-eye view and from the side;

FIG. 2 shows two turbines in a V-shape in bird's eye view;

FIG. 3 shows a turbine from the side;

FIG. 4 shows three interconnected turbines in bird's eye view;

FIG. 5 shows how the turbine can be used in a flow;

FIG. 6 shows an option from the side.

### SUMMARY OF THE REFERENCE NUMBERS REFERRING TO THE DRAWINGS

1 Plow
2 Shaft for landing
3 Blades
4 Belt
5 Shaft
6 Rail
7 Water flow
8 Area with weaker flow
9 Caster
10 Floatation device for assisting blades on a horizontally placed turbine
11 Coupling among several turbines
12 Frame/housing
13 Wheels, impeller wheels, sprockets. Control device to help put blades in the right position
14 Surface
15 Second belt
16 Fluid flow (water, air)

### DETAILED DESCRIPTION

The turbine system consists of one or more turbines, each of which may comprise an associated plow 1.

The turbine as such has blades 3 which tilt out from a belt 4 when a fluid flow 7 hits the blade directly, the blade goes appr. 90 grader out/up, so that the desired moment arm is achieved, i.e. the blades lie flat against the belt as soon as they meet resistance. This alone causes the turbine to rotate, in principle, also in a fluid with equal flows on both sides. The lever arm principle makes the longest arm “gain” rotation when an object is supported by different lengths on the moment arm. The turbine is supported by ceilings and floors for the vertical type and by walls for the horizontal type. To further reduce the resistance on the portion of the turbine not assisting in power generation, the turbine may be placed in a device for current controlling, here called plow. Moment arm is defined here as an arm to which sufficient forces are applied to cause the arm to drive the belt further with the flow and shafts of the devices around, i.e. the power-producing blades.

The task of the belt system is to provide support for the blades. The belts may be one or more chains or continuously shaped belts. A unit may be provided for each turbine to control the flow, here called plow 1, with a housing 12 around the entire device, so that there is more or less still-standing fluid under the turbine and at its rear edge, which will also contribute to the turbine meeting little resistance in the part that is sheltered from the flow. A plow may be of the “half plow” type for the use with a single turbine or a full plow with V-shape for use with two turbines. The turbine can be controlled by changing the configuration of the respective plow 1, typically by raising or lowering the plow with a control system for height adjustment of the plow, typically performed with hydraulics. The length of the plow 1 can also be controlled via a control system for length adjustment of the plow.

In a simple embodiment, blades are folded in and out with the flow. In a more advanced embodiment, the blades fold out actively based on the position of the blade in the belt system, for example, hydraulically or mechanically. This makes it easy to stop the turbine without having to stop the fluid flow and creates less resistance when the blade is moved against the flow.

In addition, if necessary, it may be appropriate to have an auxiliary system for lifting and retracting blades, in particular, under special conditions.

An alternative solution in ocean currents or tides: Here the turbine may be placed floating in the ocean skin with the energy-providing blade(s) immersed in flow 7; the blades will fall into place because of gravity; otherwise, the same principle as for the river application.

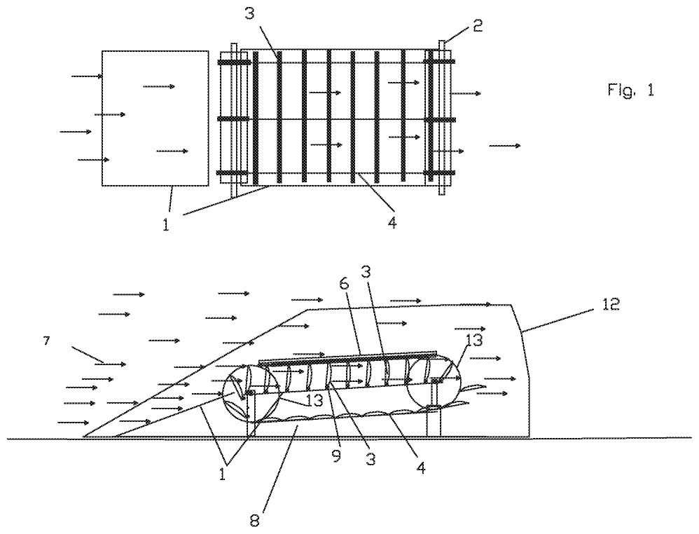

FIGS. 1a and 1b show an embodiment in which one or more turbines are placed horizontally in the river, with only one turbine per “plow” (half plow). FIG. 1 shows the turbines in bird's eye view and FIG. 1b is shown from the side across the direction of the flow. The figures illustrate a turbine comprising multiple blades 3 on at least one continuously shaped belt 4, which may be a chain or other form of belt, adapted to be run in a loop or circle, where each blade 3 is rotatably secured with its first end to the inside of the belt 4 and is arranged to fold out from the belt, toward the center of the loop, to be carried with the flow of the fluid 7, and is arranged to fold in toward the belt when the blade is led against the flow. The turbine comprises [sic] wherein the turbine further comprises at least two shafts 5 for supporting belt 4 via respective impeller wheels or sprockets 13. Between the two shafts 5, a plow 1 is arranged with a surface, wherein each blade 4 is secured with its second end to be supported and guided along the plow 1 between the shafts 5. Since blades 3 are hinged to belt 4, the surface of the inward-facing plow prevents the blades 3 from tilting backward in the direction of the flow. To achieve this effect, it is beneficial to have the distance between belt 4 and plow 1 shorter than the length of blade 3. The plow also prevents the fluid flow from draining.

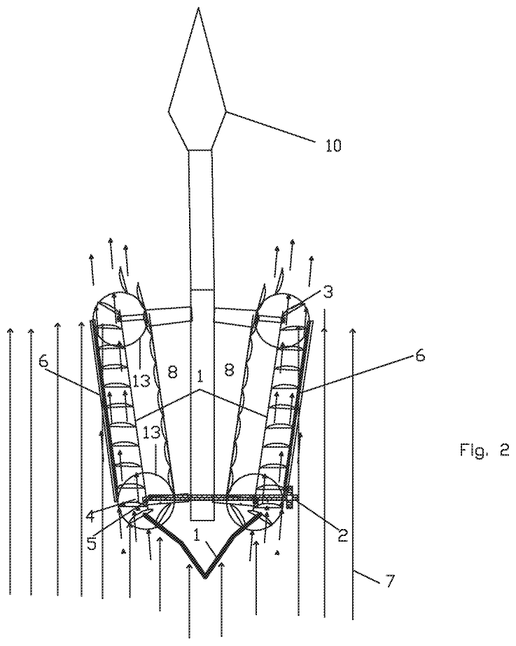

FIG. 2 shows a bird's-eye view of two turbines interconnected by a common shaft 2 arranged between the first and second turbines to provide a mechanical and electrical connection between the turbines, wherein the shaft 2 may be connected to means for generating electricity, where the means for generating electricity is a generator. The said two turbines are arranged close to each other, with the plow 1 being arranged between the turbines, mostly from the center of the front shaft of the first turbine to mostly the center of the front shaft of the second turbine. In this embodiment, a common V-shaped plow 1 is positioned at the front to guide the flow 7 towards the blades 3 and a floatation device 10, which acts as a pendulum or “weathercock” downstream of the turbine. With such a floatation device 10, the turbine is suitable for flowing a fluid and turning according to the flow, which is advantageous if used in tidal currents.

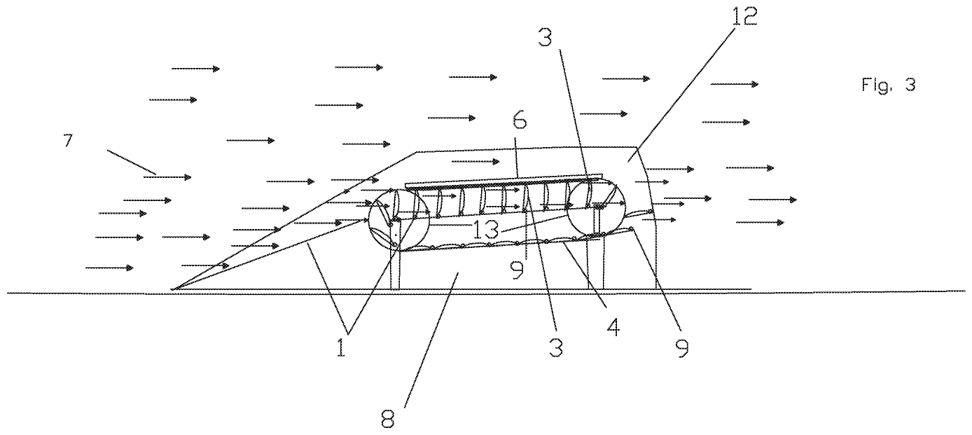

In FIG. 3, the turbine is shown from the side in an alternative embodiment in which each blade 3 at its other free end has a rotatable caster 9 or wheels adapted to be guided along the surface of the plow 1.

In an alternative embodiment, belt 4 may be comprised of two or more parallel guides, wherein each blade 3 is rotatably secured with its first end between parallel guides. To hold belt 4 or its chains in place, the turbine may comprise a rail 6 adapted to guide belt 4. FIG. 3 also shows a housing 12 around the entire device, so that there is more or less still-standing fluid under the turbine and at its rear edge, which will also contribute to the turbine meeting little resistance in the part that is sheltered from the flow.

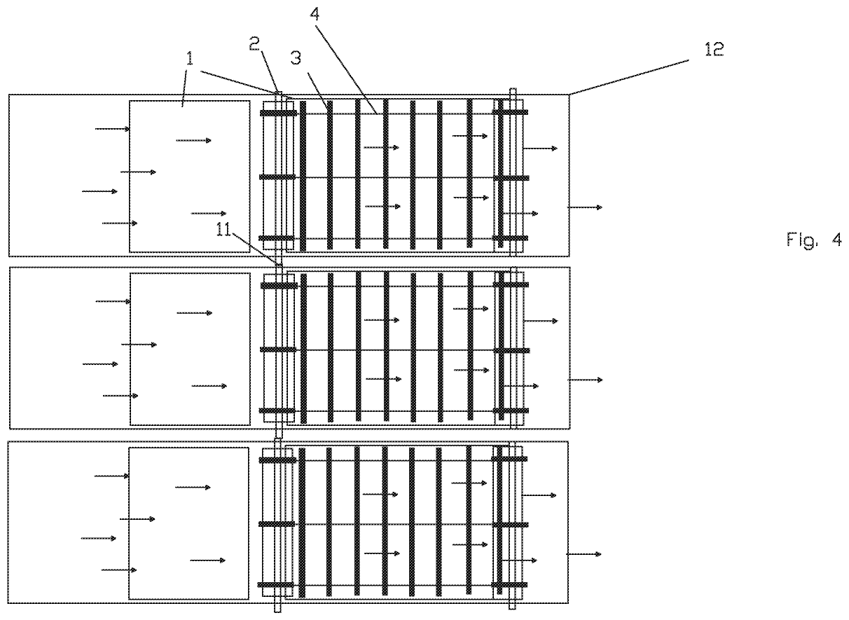

FIG. 4 shows in bird's-eye view an embodiment of several turbines, comprising belt system 4 and blades 3, placed vertically in a flow, and may then have several turbines and several plows 1, i.e. several plows with turbines can obviously be placed side by side in the flow (e.g., the river).

The size of such a production unit may vary from place to place, depending on depth and width. At great depth, the horizontal type can have large blades, with the width of the module being determined by the speed of the water (how long can each turbine shaft be before it becomes necessary to rearrange against the bending, etc.). From the area where production will take place, it must be determined how many modules can be connected per shaft and torque consumer.

FIG. 4 also shows how turbines can be connected with couplings 11 to cover a desired width in a river. This will also make it easy to replace a module during maintenance.

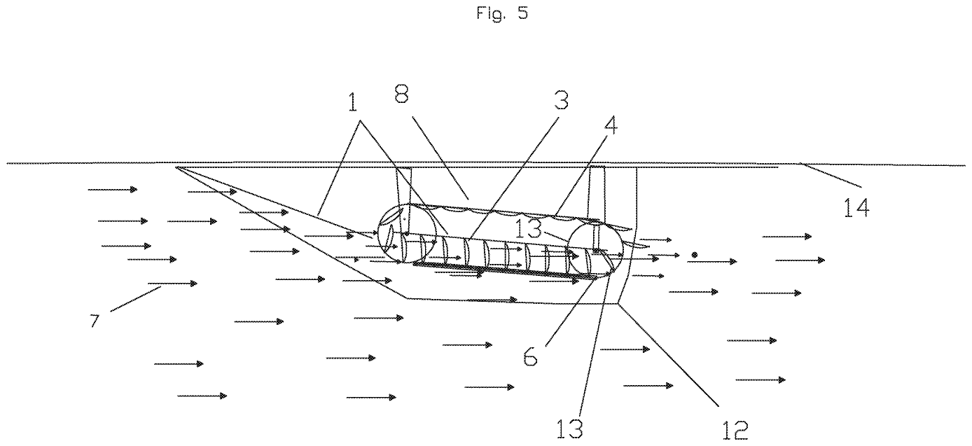

FIG. 5 shows how the turbine can be placed floating near the water surface 14 with the blades upside down in relation to the submerged option. The turbine can also be positioned with the shafts directly in the surface layer, so that the return part of the belt and the blades go above the water surface. Gravity will help to get the blades in the correct positions.

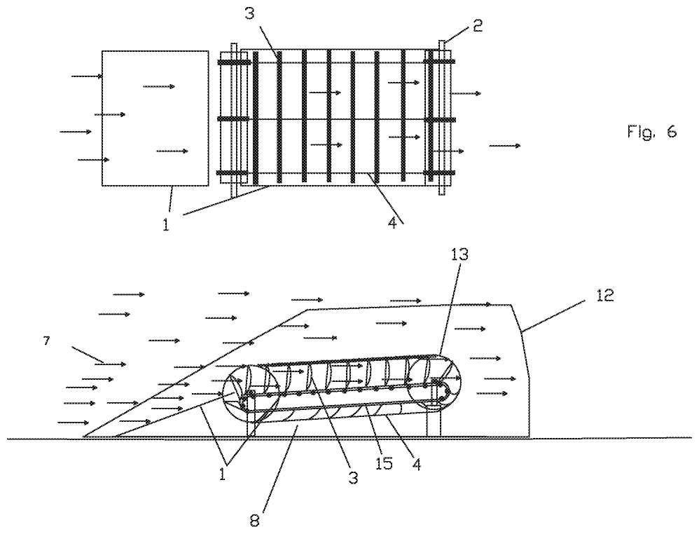

FIG. 6 shows an alternative embodiment of the invention, where a second belt 15 is provided and adapted to be guided in a loop on the inside of the belt 4 by the respective impeller, and where each blade 3 is rotatably secured with its other end to the other belt 15 on the outside of the belt. To ensure that the blades lie flat when guided against the flow 7, the distance between the belt 4 and the second belt 15 may have the first distance on the first side of the turbine, and another one where the distance between the belt 4 and the other belt 15 is the second distance on the second side of the turbine, where the first distance is greater than the second distance, so that blades 3 can be “lifted” with the flow 7 and put down against the flow.

Furthermore, a method is provided for generating electricity by a fluid flow 7, wherein at least one or more turbines are arranged in the fluid flow 7, and wherein the method comprises bringing at least one blade 3 into the first position, wherein the blades 3 are arranged longitudinally along the belt (4), where the blade 3 is led up against the flow with its first rotatable end. Blade 3 is further brought to the second position, wherein the blade 3 is led at an angle against the flow 7, with the blade being rotated at an angle relative to its first position and to the belt 2. The blade 3 is further brought to the third position, wherein the blade 3 is arranged perpendicularly to the flow 7 and belt 4, with the other end of the blade 3 being led along a surface of the plow 1. The blade 3 is further brought to the fourth position, wherein the angle of the blade 3 to the flow and belt 4 is the same as in the third position, wherein the blade 3 is moved in the flow 7 in the direction downstream from its third position. Wherein the method comprises driving multiple blades successively from the first to the fourth position of the current, and wherein the rotation of the belt 4 drives a shaft 2 connected to means for generating electricity, where the means for generating electricity is a generator.

1. A turbine comprising multiple blades on at least one continuously shaped belt configured to run in a loop,
wherein each blade of the multiple blades comprises a first end, and is rotatably secured with the first end to an inside of the belt,
wherein each blade of the multiple blades is configured to fold out from the belt and toward a center of the loop,
wherein each blade of the multiple blades is configured to be carried with a flow of the a fluid and is configured to fold in toward the belt when the respective blade is led against the flow.

2. The turbine according to claim 1, wherein the turbine further comprises at least two shafts configured for supporting the belt via respective impeller wheels.

3. The turbine according to claim 2, wherein the turbine further comprises a plow, a surface of the plow arranged between the at least two shafts, and
wherein each blade of the multiple blades further comprises a second end, and is secured with the second end to be supported and guided along the plow between the at least two shafts.

4. The turbine according to claim 3, wherein each blade of the multiple blades comprises, at the second end of each blade, a rotatable caster or wheels configured to be guided along the plow between the at least two shafts,

5. The turbine according to claim 1, wherein the at least one continuously shaped belt comprises two parallel guides, wherein each blade is rotatably secured with its first end between parallel guides.

6. The turbine according to claim 1, wherein the turbine is provided with a plow configured to direct the flow mostly toward one edge of the turbine.

7. The turbine according to claim 6, wherein the plow is provided with a control system for height adjustment of the plow.

8. The turbine according to claim 6, wherein the plow is provided with a control system configured for adjusting a length of the plow.

9. The turbine according to claim 1, further comprising a second belt configured to be guided in a second loop on an inside of the belt, wherein each blade of the multiple blades of the belt is rotatably secured to the second belt with a second end of each blade different from the first end on an outside of the second belt.

10. The turbine according to claim 9, wherein the belt and the second belt are spaced apart by a first distance on a first side of the turbine, and by a second distance on a second side of the turbine, and
wherein the first distance is greater than the second distance.

11. The turbine according to claim 1, wherein the turbine further comprises a rail on one side of the belt adapted to guide the belt or portions thereof.

12. A system comprising at least two turbines according to claim 1, wherein the two turbines include a first turbine and a second turbine that are arranged,
wherein a plow is arranged between the two turbines, from the center of a front shaft of the first turbine to the center of a front shaft of the second turbine.

13. The system according to claim 12, further comprising a common shaft arranged between the first turbine and the second turbine,
wherein the common shaft is configured to provide a mechanical and electrical connection between the two turbines, and
wherein the common shaft is connected to means for generating electricity, the means for generating electricity comprising a generator.

14. A method for generating electricity using the flow of the fluid and at least one turbine according to claim 1 arranged in the fluid, wherein the method comprises bringing a blade of at least one blade of the belt into:
a) a first position, where the blade is arranged longitudinally along the belt and is led up against the flow with the first end,
b) to the a second position after the first position, where the blade is led at an angle against the flow, with the blade rotated at an the angle relative to the first position and to the belt,
c) a third position after the second position, where the blade is arranged perpendicularly to the flow and the belt, with a second end of the blade led along a surface of a plow of the turbine, and
d) a fourth position after the third position, where the angle of by which the blade is led against the flow and at which the blade is rotated relative to the belt is the same as the angle in the third position, and where the blade is moved in a downstream direction of the flow downstream from the third position.

15. The method according to claim 14, wherein the method further comprises driving multiple blades of the at least one blade of the belt successively from the first position to the fourth position, and wherein a rotation of the belt drives a shaft connected to means for generating electricity, where the means for generating electricity comprises a generator.

16. A method for generating electricity using the flow of the fluid and the system according to claim 12 arranged in the fluid, wherein the method comprises bringing a blade of at least one blade of the belt into:
a) a first position where the blade is arranged longitudinally along the belt and is led up against the flow with the first end,
b) a second position after the first position, where the blade is led at an angle against the flow, with the blade rotated at the angle relative to the first position and to the belt,
c) a third position after the second position, where the blade is arranged perpendicularly to the flow and the belt, with a second end of the blade led along a surface of a plow of the turbine, and
d) a fourth position after the third position, where the angle by which the blade is led against the flow and at which the blade is rotated relative to the belt is the same as the angle in the third position, and where the blade is moved in a downstream direction of the flow from the third position.
